(19) United States
(12) Patent Application Publication
(10) Pub. No.: US 2021/0166901 A1
(43) Pub. Date: Jun. 3, 2021

(54) High-voltage switch, high-voltage on-board power supply network in a motor vehicle and method for operating a high-voltage switch

(71) Applicant: Auto-Kabel Management GmbH, Hausen i.W. (DE)

(72) Inventors: David Cacciatore, Kempen (DE); Wacim Tazarine, Erkelenz (DE); Sohejl Rafati, Mönchengladbach (DE)

(21) Appl. No.: 17/047,138

(22) PCT Filed: Jan. 17, 2019
(86) PCT No.: PCT/EP2019/051174

§ 371 Date: Oct. 13, 2020

(30) Foreign Application Priority Data
Apr. 24, 2018 (DE) 10 2018 109 824.3

(51) Int. Cl. H01H 39/00; H01H 1/50; H01H 1/14; B60L 3/00; B60L 3/04

(52) U.S. Cl. CPC H01H 39/00; H01H 1/50; B60L 3/04; B60L 3/0007; H01H 1/14

(57) ABSTRACT

High-voltage switch with a first terminal contact connected to a first fixed contact, a second terminal contact connected to a second fixed contact, a bridge contact arranged between the first fixed contact and the second fixed contact and connecting the first fixed contact to the second fixed contact, the bridge contact being pressed against at least one of the fixed contacts with a contact pressing force and being able to be released from at least one of the fixed contacts with a pull-off force, and a drive acting on the bridge contact in the direction of the pull-off force. A measuring circuit senses a voltage drop between the fixed contacts in case of levitation between at least one fixed contact and the bridge contact and depending on the sensed voltage drop controls the drive in such a way that the drive acts on the bridge contact with a force in the direction of the pull-off force.

The subject matter relates to a high-voltage switch, especially in automotive applications, for example in hybrid electric vehicles (HEV), battery electric vehicles (BEV) or fuel cell vehicles (FCV). Furthermore, the subject matter relates to a method for operating such a high-voltage on-board power supply network.

The share of electrically powered vehicles will increase in the future. A gradual transition from fossil fuels to electric vehicle drives can be observed. The subject matter is for example useful in hybrid vehicles (HEV), battery electric vehicles (BEV) as well as in fuel cell vehicles (FCV).

As the share of electrically powered vehicles, especially with electric primary drives, will increase in the next years and decades, the requirements for on-board power supply networks will change considerably. Decisive for the acceptance of electric drives is the reliability and safety of the high-voltage on-board power supply network.

Depending on the degree of electrification, i.e. what proportion of the drive power is electrical, the electrical power is in the range between 10 and 120 KW. Compared to conventional 12V on-board power supply networks, the operating voltage in the on-board power supply networks of electrically powered vehicles is considerably higher. This is made possible by integrating high-voltage batteries as rechargeable energy storages. Due to the considerably higher operating voltages, the complexity of the on-board energy supply network increases and thus also the demands on on-board components such as relays, conductors and fuses.

Reliable switch-off of the high-voltage on-board power supply network from the high-voltage battery is a very important point, especially at safety-critical moments. With voltages of up to 1000V DC and short-circuit currents in the kilo ampere range, the demands on switching relays and fuses are considerable. The reliable switching behavior of the relays and fuses must be ensured both in normal operation and in the event of an accident. During normal operation, switching is required at considerably lower currents than in the event of an accident or fault. During normal operation, e.g. during maintenance and repair, while galvanic isolation is required, the currents to be switched are relatively low. Switching off can be made possible by switching relays during normal operation or in other unusual situations in which no short-circuit current flows.

In case of a short circuit, however, considerably higher currents flow and even then a safe switch-off must be possible. Conventionally, both high-side and low-side a combination of fuses and relays is used for this purpose. The fuses are used for switch-off in case of a short circuit, whereas the relays are usually used for switch-off in case of normal operation.

From DE 10 2016 101 252 A1 a high-voltage on-board power supply network is known in which a switching voltage is reduced by utilizing the levitation at the switching relay.

It has been recognized according to the subject matter that the conventional combination of fuse and relay signifies a considerable effort. The design of the respective combination of fuse and relay must be coordinated to ensure a safe fuse tripping even in case of a short circuit. It has also been recognized that previous circuits are complex and costly due to different switching components. In addition, a triggering signal for triggering a pyrotechnical fuse is not available at all points in the vehicle where an emergency switch-off might be necessary. Especially an additional wiring should be avoided and still sufficient safety should be provided.

Thus the subject matter was based on the object to provide a high-voltage switch which guarantees a safe release in case of a fault with few components.

This object is solved by a high-voltage switch according to claim 1, a high-voltage on-board power supply network according to claim 15 and a method according to claim 16.

An high-voltage switch according to the subject matter is preferably arranged between a high-voltage battery and an electric drive. In contrast to conventional 12V, 24V or 48V vehicle on-board power supply networks, in high-voltage on-board power supply network of electrically powered vehicles both the battery positive pole (high-side) and the battery negative pole (low-side) are connected to the electric motor via an electric cable. In these cases the ground return is not routed via the body.

High-voltage batteries according to the subject matter are preferably rechargeable energy storages, which can provide output voltages between some 100V up to some 1000V directly or via suitable step-up converters. On the output side of the high-voltage on-board power supply network, a DC/DC converter is usually provided to convert the input voltage into a suitable output voltage for the electric drive. The output voltage at the energy storage is applied as direct voltages (DC) to the electric drive motor via the electrical lines of the high-voltage on-board power supply network.

The electric drives are operated at very high power levels, ranging from 10 kW to over 120 kW. Even at the high voltages mentioned above, these high power levels still require very high currents.

During normal operation, such high currents are usually routed through the high-voltage switch. It has now been recognized that for an emergency switch-off, for example in case of a crash, the levitation in the high-voltage switch can be used as switching impulse.

Because very high currents occur in an emergency, e.g. in case of a short circuit, a so-called levitation can occur at the high-voltage switch, over which the short circuit current is routed. Levitation is also known as “electric magnetic repulsion”. In this case, a forced movement of the bridge contact occurs in the relay despite the coil being activated. This is caused by an electromagnetic repulsion between two conductors through which current flows in opposite directions. In the case of the high-voltage switch, the repulsion is caused by the fact that the fixed contact does not form a full-surface contact with the bridge contact. This causes the current to flow through the fixed contact to the contact point with the bridge contact. The contact point is a narrow passage somewhere on the end faces which are between the fixed contact and the bridge contact. The current must therefore flow along the lateral surface of the fixed contact, over the end face of the fixed contact to the narrow passage and from there over the end face of the bridge contact back to the lateral surface of the bridge contact. Thus the current flows on the end faces are opposed to each other. The resulting non-orthogonal current directions lead to a repulsion between the bridge contact and the fixed contact. If levitation occurs in the relay, contact openings can occur, and electric arcs can be created between the bridge contact and the fixed contact via this contact opening.

According to the subject matter, the increased resistance caused by the levitation is used to avoid an additional provision of a control line. The ignition voltage for a drive, especially a pyrotechnic drive, is built up directly above the burning electric arc of the bridge contact, so that without an external ignition impulse the switch is disconnected by the disconnecting circuit, especially the pyrotechnic drive.

The high-voltage switch according to the subject matter has a first and a second fixed contact, both of which are preferably located in the housing of the high-voltage switch.

Each of the fixed contacts can be contacted via a terminal contact located on the outside of the housing. In particular, a first terminal contact is indirectly connected to the energy storage and a second terminal contact is indirectly connected to a drive train. A direct connection without an intermediate network of electrical and electronic components is also possible.

The fixed contacts of the high-voltage switch are short-circuited to each other via a bridge contact when the high-voltage switch is closed. For this purpose the bridge contact is pressed against at least one, preferably both fixed contacts with a contact pressure force. By lifting the bridge contact the electrical connection between the two fixed contacts can be switched off. The high-voltage switch is preferably formed as a normally open switch. By energizing a coil, a closing can cause the connecting of the fixed contacts by pressing the bridge contact against at least one, preferably both fixed contacts.

The bridge contact is preferably movable in relation to both fixed contacts, but can also be attached to one fixed contact and only be movable relative to the second fixed contact.

When switching off to zero current in normal operation, the bridge contact is lifted off at least one of the fixed contacts. This is the normal operating condition in which switching is unproblematic, since the currents to be switched are a few 100A maximum.

If a force is applied to the bridge contact opposite to the contact pressure, the bridge contact can be lifted off the fixed contacts. A drive is provided for this purpose, which can cause this lifting.

In an emergency, for example in case of a crash or other short circuit, currents can flow through the high-voltage switch which are much higher than the currents flowing in normal operating conditions.

These currents flowing in the event of a fault are so high that there can be levitation between at least one fixed contact and the bridge contact as described above. Because of the currents flowing in opposite directions at the end faces of the fixed contact and the bridge contact the bridge contact is lifted from the fixed contact against the contact pressure. The electromagnetic repulsion force between the bridge contact and at least one of the fixed contacts caused by the high electrical currents can be greater than the contact pressure.

Since in this case the separation process is rapid and the distance between the bridge contact and the fixed contact is only a few tenths of a millimeter to a few millimeters, an electric arc is formed between the fixed contact and the bridge contact immediately at separation. A residual current flows over the electric arc from the fixed contact to the bridge contact or vice versa.

In normal operation, the high-voltage switch is closed and the voltage drop between the two fixed contacts is almost zero. The fixed contacts are short-circuited via the bridge contact and a contact resistance can be less than 1 mΩ. Even at high currents, there is only an extremely small voltage drop in this case between the fixed contacts or the terminal contacts connected to the fixed contacts.

A measuring circuit, for example a passive resistor, can be connected in parallel to the fixed contacts. This measuring circuit can be used to detect a voltage drop between the fixed contacts. The measuring circuit is preferably passive and is designed to sense the voltage drop between the fixed contacts in case of levitation between at least one fixed contact and the bridge contact. Such a voltage drop can evaluate to some 10V up to some 100V.

If a previously determined voltage drop is detected, the measuring circuit can control the drive in such a way that the drive acts on the bridge contact with a force in the direction of the pull-off force. Thereby the drive causes the still burning electric arc to be extinguished by distancing the bridge contact and the fixed contact. The drive only has to make sure that the remaining current flowing through the electric arc is disconnected. Thus the levitation causes the drive to trip without an external trigger signal. The voltage drop across the electric arc is sufficient to trigger the drive.

The measuring circuit is designed to detect, in particular passively detect, when the voltage drop between the fixed contacts and the bridge contact is caused by the levitation. In this case the drive is automatically triggered in such a way that it acts mechanically on the bridge contact. In this case, a force acts in the direction of the pull-off force. This force causes a disconnection of the electrical connection between the two fixed contacts via the bridge contact, which is still established via the electric arc.

In the event of a short circuit on the drive train side, a short-circuit current flows via the high-voltage switch which causes the levitation. The voltage drop caused by the levitation automatically triggers the drive so that the drive can act against the bridge contact and thus disconnect any remaining electrical connection between the fixed contacts. An external control line is not required.

The drive is preferably a pyrotechnic drive which can be triggered by the voltage drop between the fixed contacts. Inside the pyrotechnic drive, a measuring resistor may be provided which is heated by the current flowing through the fixed contacts due to the voltage drop in such a way that the pyrotechnic drive is automatically activated. Such a resistor can be the measuring circuit. Thus, a passive circuit can be used to achieve a very safe separation of the high-voltage switch even in case of a short circuit. The high-voltage switch without the drive only needs to be designed for the separation of the normal operating currents. This leads to considerable cost advantages compared to a high-voltage switch which has to be designed to also disconnect the short-circuit currents. The high voltage switch according to the subject matter must be able to disconnect the operating currents in case of normal operation. In case of a fault, a possibly incomplete disconnection of the high voltage switch is definitely disconnected by the additional drive.

The bridge contact is preferably spring-loaded with a contact pressure against the fixed contacts. It is also possible that the bridge contact is pressed against the fixed contact by a magnetic force.

According to an embodiment, it is proposed that the measuring circuit is powered by the voltage between the fixed contacts. Due to the voltage drop in case of the levitation between the fixed contact and the bridge contact, a current flow through the measuring circuit occurs. Thus the measuring circuit is fed. This leads to a triggering of the drive in such a way that the drive acts on the bridge contact with a force in the direction of the pull-off force.

According to an embodiment, it is proposed that the measuring circuit is passive. A passive measuring circuit has the particular advantage that no additional electrical supply line to the high-voltage switch is necessary to enable it to disconnect short-circuit currents. In fact, a high voltage switch according to the subject matter can safely disconnect a short circuit current without additional wiring. The drive is formed in such a way that it automatically trips when a voltage between the fixed contacts is exceeded. The sole triggering criterion can be the voltage between the fixed contacts. A defined resistance of the measuring circuit leads to a defined current through the measuring circuit depending on this voltage drop, which can be responsible for the triggering of the drive.

According to an embodiment it is proposed that in case of levitation such a high current flows through the drive that the drive is triggered. Thereby, the levitation is the sole triggering criterion and leads to a definite separation independent of an additional assembly.

The high-voltage switch according to the subject matter or its drive must be designed in such a way that the drive can disconnect a residual current that flows due to levitation. This separation can be achieved by the drive accelerating the bridge contact in the direction of the pull-off force and thus extinguishing the electric arc. It is also possible that the drive cuts the bridge contact in the direction of the pull-off force. In the case of levitation, a lower current flows over the bridge contact than the short-circuit current. The current is determined by the resistance of the electric arc. If the bridge contact is cut, only this flowing current needs to be switched off. At the point of separation along the bridge contact, no further electric arc is formed because the current over the bridge contact is not large enough anymore. Instead, the still burning electric arc between the bridge contact and at least one fixed contact is extinguished by cutting the bridge contact.

Cutting through or lifting the bridge contact is preferably possible through the drive having a bolt. If the drive is triggered, the bolt is preferably accelerated pyrotechnically due to the explosion energy in the direction of the pull-off force onto the bridge contact. The bridge contact can be separated by the bolt. The bolt can have a cutting surface on its end face facing the bridge contact. In particular, the bolt is tapered in the direction of the bridge contact so that it can be passed through the bridge contact like a knife.

It is also possible that the bridge contact can be lifted off one or both fixed contacts by the bolt. In this case, the bolt can press against a lower surface of the bridge contact which points towards the fixed contacts. The momentum of the bolt accelerates the bridge contact away from the fixed contacts and lifts it off at least one of them. This increases the distance between the fixed contacts and the bridge contacts, thus extinguishing a burning electric arc.

As already explained, the high voltage switch has a housing. It is preferred that the bolt is guided in the housing in which the fixed contacts and the bridge contact are also arranged.

Furthermore, the drive can be at least partially located in the housing.

It is also possible that the drive can be additionally triggered by an external control signal. Such an external control signal can be a crash signal, e.g. an airbag control signal. In the event of a crash without a short circuit occurring, the energy storage system must be disconnected from the drive train. A crash signal, e.g. an airbag control signal, can be applied to the drive and trigger the drive according to the activation in case of levitation. For example, the pyrotechnic drive is ignited by the external signal and this causes the bridge contact to be lifted off the fixed contacts. In this case, in which no short-circuit current is flowing, only an operating current flows through the high-voltage switch and this current can be easily separated by lifting the bridge contact from the fixed contacts.

According to an embodiment it is proposed that the measuring circuit senses a voltage drop in a voltage band. The voltage band is defined by a lower and an upper limit voltage. The upper limit voltage is lower than the voltage of the energy storage device which can be connected to the high voltage switch. Only if the voltage drop is within the voltage band, the measuring circuit triggers the drive.

In the following, the subject matter is explained in more detail by means of a drawing showing examples. In the drawing show:

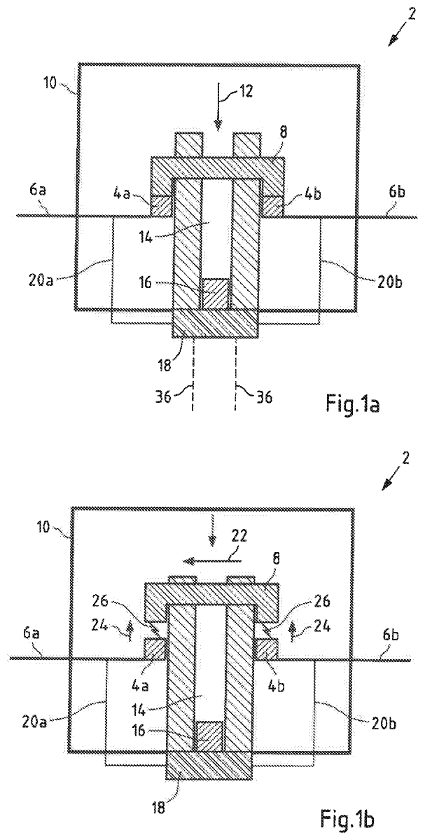

FIG. 1a-c a schematic view of a high-voltage switch according to an embodiment;

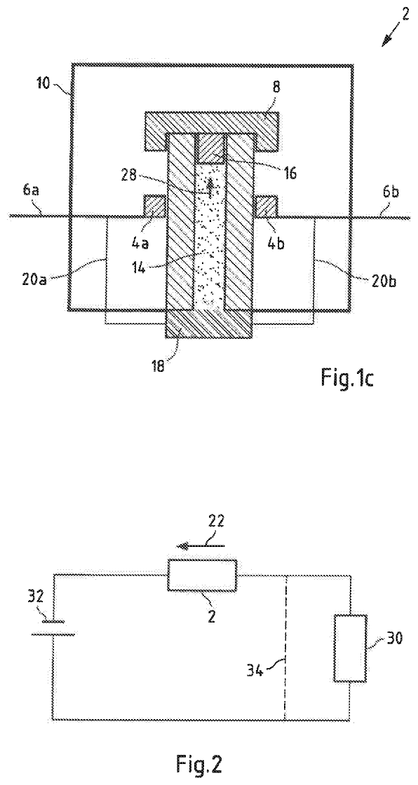

FIG. 2 a schematic view of a motor vehicle on-board power supply network.

FIG. 1 shows a high-voltage switch 2 with a first fixed contact 4a connected to a first terminal contact 6a and a second fixed contact 4b connected to a second terminal contact 6b. The fixed contacts 4a, b are short-circuited with each other via a bridge contact 8.

The fixed contacts 4a, b and the bridge contact 6 are arranged inside a housing 10. Within the housing 10 the fixed contacts 4a, b are arranged in a fixed position and for example firmly anchored to the housing. In contrast, the bridge contact is movable, especially parallel to the direction 12 in the housing 10.

Direction 12 indicates a force direction by which the bridge contact 8 is pressed against the fixed contacts 4a, b.

In the region of the bridge contact 8, especially in the center of the bridge contact 8 between the fixed contacts 4a, b, a firing channel 14 is arranged. The firing channel 14 guides a bolt 16, which can be driven by a pyrotechnic drive 18.

The pyrotechnical drive 18 is arranged as a measuring circuit and is short-circuited with the fixed contacts 4a, 4b via measuring leads 20a, 20b respectively. Thus a voltage is tapped between the fixed contacts 4a, b by the drive 18. In the drive 18, a resistor not shown here may be provided which, when there is a voltage between the fixed contacts 4a, 4b, heats up due to the flowing current and thus, for example, ignites the pyrotechnic charge in the drive 18.

In FIG. 1a the switch 2 is shown in the closed position and the bridge contact 8 forms a short circuit between the fixed contacts 4a, 4b. Thus there is no relevant voltage drop across the fixed contacts 4a, b and the drive 18 is not activated.

By means of a mechanism not shown, the bridge contact 8 can normally be lifted from the fixed contacts 4a, b. During normal operation, a current flows via the bridge contact 8, which can be disconnected easily by lifting the bridge contact 8 from the fixed contacts 4a, b. The bridge contact 8 can also be lifted from only one of the fixed contacts 4a, b and be permanently connected to the other one of the fixed contact 4a, b. This function is well known from conventional relays.

In case of a fault, especially in case of a short-circuit, the current flowing through the fixed contacts 4a, b and the bridge contact 8 may be a multiple of the normal operating current. Such an increased current can lead to a levitation of the bridge contact 8 from at least one of the fixed contacts 4a, b. This is shown in FIG. 1b.

In FIG. 1b it can be seen that a large current 22 flows across the bridge contact 8. This large current 22 can be caused by a short circuit, for example. This high current 22 causes a levitation of the bridge contact 8 from the fixed contacts 4a, b. Currents in opposite directions at the end faces of at least one of the fixed contacts 4a, b and the bridge contact 8 lead to an electromagnetic force 24 which causes repulsion between the bridge contact 8 and the fixed contacts 4a, b. Due to this repulsion, a gap is formed between the bridge contact 8 and at least one of the fixed contacts 4a, b. Since very high currents 22 are handled by the switch, an electric arc 24 ignites immediately, which burns across the gap between the bridge contact 8 and at least one of the fixed contacts 4a, 4b.

This electric arc 24 has a greater resistance than a direct contact between the fixed contacts 4a, b and the bridge contact, so that a voltage drop between the fixed contacts 4a, 4b is greater than a voltage drop in the closed state according to FIG. 1a.

Due to the increased voltage drop, a current flows from the fixed contact 4a via the measuring leads 20a, 20b and the drive 18. This current causes the drive 18 to be ignited.

At the moment of ignition of the drive 18, the bolt 16 in the firing channel 14 is accelerated in the direction 28 and hits the bridge contact 8. The bolt 16 can cut the bridge contact 8 or lift it off further from the fixed contacts 4a, 4b. Both the cutting and the lifting will cause the electric arc 24 to extinguish. Switch 2 is then completely open and no current flows through switch 2.

FIG. 2 shows a block diagram with a switch 2, a drive train 30 and an energy storage 32. Normally, a normal operating current flows through switch 2, which can be easily switched off by lifting the bridge contact 8 from at least one of the fixed contacts 4a, 4b.

In the case of a short circuit, represented by the dotted line 34 in FIG. 2, the drive train 30 is short-circuited. The internal resistance of the drive train 30 approaches zero and the energy storage 32 is almost short-circuited via switch 2 and the short circuit 34. This leads to a very high short-circuit current 22, which results in the levitation just described. The high-voltage switch 2 then self-sufficiently carries out a disconnection as described above, independently of an external disconnection signal.

In addition to the described separation, the high-voltage switch or the drive 18 can be driven via control lines 36. The control lines 36 can, for example, be activated in the event of a crash, which in particular occurs without a short circuit, and thus activate the drive 18 in such a case as well. This also leads to a safe disconnection or opening of switch 2 in case of a fault condition that does not cause a short circuit. However, the control line 36 is optional. In the case of the control line, lines 20a, 20b can be electrically decoupled from control line 36, so that a current flow between control line 36 and lines 6a, b can be avoided.

1-16. (canceled)

17. A high voltage switch comprising:
a first terminal contact connected to a first fixed contact;
a second terminal contact connected to a second fixed contact;
a bridge contact arranged between the first fixed contact and the second fixed contact connecting the first fixed contact to the second fixed contact, wherein the bridge contact is pressed against at least one of the fixed contacts with a contact pressure force and can be released from at least one of the fixed contacts with a pull-off force;
a drive acting on the bridge contact in the direction of the pull-off force; and
a measuring circuit configured to sense a voltage drop between the fixed contacts in the event of levitation between at least one fixed contact and the bridge contact, such that depending on the sensed voltage drop, the drive is controlled in such a way that the drive acts on the bridge contact with a force in the direction of the pull-off force.

18. High voltage switch according to claim 17,
wherein the drive is a pyrotechnic drive which can be triggered by the voltage drop between the fixed contacts.

19. High-voltage switch according to claim 17,
wherein the bridge contact is in a spring-loaded way pressed against at least one of the fixed contacts with the contact pressure force.

20. High-voltage switch according to claim 17,
wherein the measuring circuit is fed by the voltage between the fixed contacts.

21. High voltage switch according to claim 20,
wherein the measuring circuit is passive and is formed by the drive in such a way that the drive triggers when a voltage between the fixed contacts is exceeded.

22. High voltage switch according to claim 17,
wherein in case of levitation a current flows via the drive, which triggers the drive.

23. High voltage switch according to claim 17,
wherein the drive accelerates the bridge contact in the direction of the pull-off force or that the drive cuts the bridge contact in the direction of the pull-off force.

24. High voltage switch according to claim 17,
wherein the drive has a bolt which accelerates in the direction of the pull-off force onto the bridge contact in the event that the drive is triggered.

25. High voltage switch according to claim 24,
wherein the bridge contact can be separated by the bolt.

26. High-voltage switch according to claim 24,
wherein the bridge contact can be lifted from both fixed contacts by the bolt.

27. High voltage switch according to claim 24,
wherein the bolt is guided in a housing in which the fixed contacts and the bridge contact are arranged.

28. High-voltage switch according to claim 17,
wherein the drive is at least partly arranged in the housing in which the fixed contacts and the bridge contact are arranged.

29. High voltage switch according to claim 17,
wherein the drive can be additionally triggered by an external control signal.

30. High voltage switch according to claim 17,
wherein the measuring circuit is arranged for sensing a voltage in a voltage band, wherein the voltage band has a lower limit voltage and an upper limit voltage, the upper limit voltage being lower than the voltage of the energy storage which can be connected to the high-voltage switch, and the measuring circuit is configured to activate the drive only for a sensed voltage inside the voltage band.

31. A high-voltage on-board power supply network in a motor vehicle, in which the high-voltage switch according to claim 17 is arranged electrically between an energy storage and a drive train.

32. Method for operating the high-voltage switch of claim 17 comprising:
sensing a voltage drop between the fixed contacts in the event of levitation between at least one fixed contact and the bridge contact; and
triggering the drive depending on the sensed voltage drop in such a way that the bridge contact is removed from the fixed contacts at least partly by means of the drive with a force in the direction of the pull-off force.
